(19) United States
(12) Patent Application Publication
(10) Pub. No.: US 2004/0222341 A1
(43) Pub. Date: Nov. 11, 2004

(54) Intravenous equipment hangers

(75) Inventors: Wayne J. Breda, Clarendon Hills, IL (US); Bradley Piper, Gold Canyon, AZ (US)

Correspondence Address: BANNER & WITCOFF, LTD., TEN SOUTH WACKER DRIVE, SUITE 3000, CHICAGO, IL, 60606, US

(73) Assignee: Health Science Technology, LLC, Rockford, IL

(21) Appl. No.: 10/795,812

(22) Filed: Mar. 8, 2004

Related U.S. Application Data
(63) Continuation-in-part of application No. 09/238,950, filed on Jan. 27, 1999, now abandoned.
(60) Provisional application No. 60/515,236, filed on Oct. 29, 2003.

(51) Int. Cl. F16L 3/00

(52) U.S. Cl. 248/200

(57) ABSTRACT

An intravenous (“IV”) infusion equipment hanger assembly is provided comprising at least one mounting plate member designed for attachment to a partition wall in a generally vertical position. A hanger which includes an elongate telescopic pole with engagement elements for hanging IV fluid containers is supported on the mounting member by an offset support arrangement that engages and extends laterally between the pole and the mounting member. Thereby the pole is spaced laterally from the mounting member in a manner that permits ready access for a caregiver person to attach the infusion pump and hand the IV containers without significant interference with or engagement by the mounting member or the partition on which it is supported. In one embodiment, the mounting member is an inverted J-shaped hanger for hooking over the upper edge of the door of an animal cage. A detent pin through the J portion of the mounting member assures retention of the support on the partition. A second latch secures a lower portion of the mounting member to the cage door. In other embodiments, the mounting member is affixed directly to the wall of a hospital room or the like, with the hanger subassembly either permanently or detachable affixed to this mounting member.

This is a continuation in part of our copending utility patent application Ser. No. 09/238,950 entitled Intravenous Equipment Hangers filed Jan. 27, 1999 and of our two previous design patent applications Serial Nos. 29/099,664 and 29/099,666, both filed Jan. 26, 1999, now U.S. D437,639 and D437,640, both issued Feb. 13, 2001, and entitled, respectively, Intravenous Equipment Hanger with Mounting Support and Intravenous Equipment Hanger. The disclosures in the above applications are incorporated herein by reference, and the benefit of their filing dates is claimed. The applicants also claim the benefit of the filing of provisional patent application Ser. No. 60/515,236 filed Oct. 29, 2003.

### FIELD OF THE INVENTION

This invention relates to supports for intravenous infusion equipment, and particularly for intravenous fluid supply bags and other containers and intravenous fusion pumps. Most particularly, it is concerned with such supports for the suspension of the intravenous equipment on partitions which define the space that houses the patient, and especially on the doors of animal cages and on the walls of rooms, with capability of being remounted on movable floor stands.

### BACKGROUND OF THE INVENTION

Many patients, both animal and human, are treated by injecting fluids intravenously from fluid containers and through infusion metering pumps, both of which must be supported neat the patient. Such containers and pumps typically are mounted on free-standing poles mounted on caster supports for convenient portability. In other instances, the supply containers are mounted on stands attached to gurneys or are hung from beds, rails or other structures. In the instances of animals being treated while confined in cages, special support and security considerations are involved.

It is an object of this invention to provide improved and simple supports for intravenous infusion equipment near a patient, and particularly hangers that are easily and securely mountable on cage doors and walls and having the ability to be moved from wall installations to mobile free-standing poles.

### SUMMARY OF THE INVENTION

An intravenous (“IV”) infusion equipment hanger assembly is provided comprising at least one mounting member that is designed for attachment to a partition wall in a generally vertical position, whereby the mounting member defines a generally vertical plane when so attached. A hanger which includes an elongate telescopic pole with engagement elements on that pole for supporting IV fluid containers, such as IV bags, on the upper end of the pole, is supported on the mounting member by an offset support arrangement that engages and extends laterally between the pole and the mounting member. Thereby the pole is supported generally parallel to the first plane and in a vertical position and spaced laterally from the mounting member in a manner that permits conveniently affixing a typical infusion pump on the pole. The offset arrangement permits ready access for a caregiver person to attach the infusion pump and hang the IV containers without significant interference with or engagement by the mounting member or the partition on which it is supported.

In one preferred embodiment, the mounting member is an inverted J-shaped hanger for holing over the upper edge of a partition or the like, and especially over the top edge of a door or other partition that defines an animal cage or other animal enclosure. Such partitions typically are fabricated of steel wire, rods or bars that provide an open or foraminous construction. A latch pin may be included in association with the upper portion of the mounting member to the partition, particularly when the assembly is being mounted on a cage door.

In other preferred embodiments, especially for mounting on a fixed wall partition of a hospital room or the like, the mounting member may to the wall. The hanger subassembly, including the offset supports, either is permanently affixed to this mounting member or preferably detachably engages the mounting member so that the hanger subassembly can be readily removed and mounted on a vertical pole on a caster base to follow a mobile patient down the hallway. This avoids obstruction of the space by the hanger equipment when not in use and also permits use of the hanger subassembly in a number of different locations with other pre-mounted mounting members.

These and other features and advantages of the invention will be more readily apparent upon reading the following description of a preferred exemplified embodiment of the invention and upon reference to the accompanying drawings.

### BRIEF DESCRIPTION OF THE DRAWINGS

FIG. 1 is an upper right front perspective view of an intravenous infusion equipment hanger assembly employing teachings of this invention, as mounted on a wire bar cage partition that is shown in dashed lines, and with the telescopic hanger bar illustrated in two positions.

FIG. 2 is an upper right rear perspective view of the apparatus of FIG. 10

FIG. 3 is a front elevational view thereof and showing in dashed lines an infusion pump mounted on the hanger pole.

FIG. 4. is a right side elevational view of the equipment of FIG. 3.

FIG. 5 is a top view of the equipment of FIG. 3.

FIG. 6 is an upper right front perspective view of another embodiment of an intravenous equipment hanger assembly employing teachings of this Invention with the telescopic hanger bar illustrated in two different positions.

FIG. 7 is an upper right rear perspective view of the assembly of FIG. 6.

FIG. 8 is an upper right front perspective view of another embodiment of an intravenous equipment hanger assembly employing teachings of this invention with the telescopic hanger bar illustrated in two different positions.

FIG. 9 is an upper right rear perspective view of the assembly of FIG. 8.

FIG. 10 is an upper right front perspective view of another intravenous equipment hanger assembly employing teachings of this invention, with the telescopic hanger bar in two different positions.

FIG. 11 is an upper right front perspective view of the hanger unit which can fit in mounting support of FIG. 12 to become an assembly as in FIG. 10 or fit in a mobile vertical pole as in FIG. 13 to become an assembly as in FIG. 14.

FIG. 12 is an upper right front perspective view of the mounting support of the assembly of FIG. 10.

FIG. 13 is a perspective view similar to FIG. 11 of a second embodiment of the hanger unit.

FIG. 14 is a perspective view of a mobile base providing for a mobile free-standing pole for the hanger unit.

While the invention will be further described in connection with certain preferred embodiments, it is not intended to limit the invention to those embodiments. On the contrary, it is intended to cover all alternatives, modifications and equivalents as may be included within the spirit and scope of the invention.

### DETAILED DESCRIPTION OF PREFERRED EMBODIMENTS

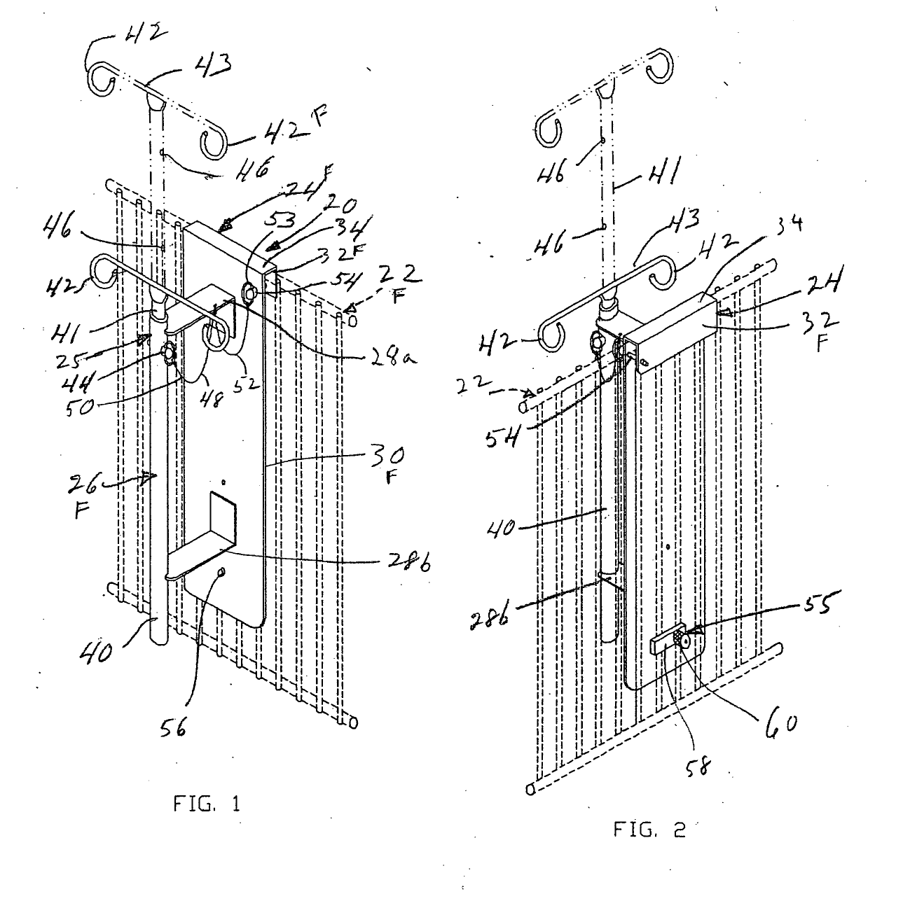

FIGS. 1-5 illustrate an intravenous equipment hanger assembly 20 that is mounted on a wire bar petition panel 22 that represents, for example, the door of an animal cage such as is often found in veterinary clinics. The hanger assembly 20 includes an inverted J-shaped mounting member 24 and a hanger subassembly 25 that includes a telescopic pole 26 which is mounted on the mounting member 24 by a pair of lateral offset support brackets 28a and 28b.

The illustrated mounting member 24 is an integral vertically elongate member that includes a main plate section 30 with a short return flange 32 joined to the mail plate body 30 by a laterally extending bight portion 34. The section 30, and the flange 32 and the bight 34 thus define a downwardly open pocket. As will be seen, the member 24 thus forms an inverted J-shape which conveniently hooks over an exposed upper edge of a partition such as the top edge of the cage door panel 22 as shown in the drawings.

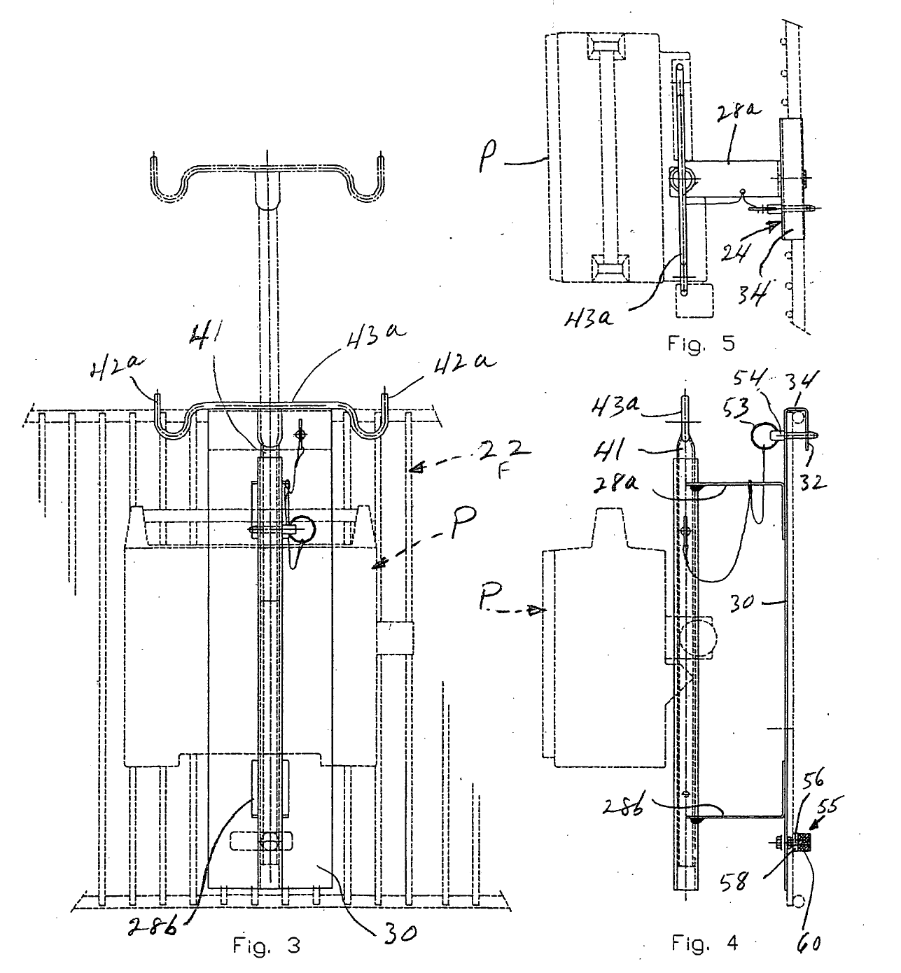

The pole 26 is telescopic, comprising a tube section 40 which is affixed to the mounting member 24 by the offset brackets 28a, 28b, and an elongate slide rod section 41 which slides telescopically into the upper end of the tube 40. The rod 41 carries hanger elements 42 on its upper end in the manner of known IV bag hangers. The brackets 28a, 28b are suitably affixed to the tube 26 and to the mail plate section 30, as by welding, riveting, adhesive, comolding or other appropriate securement means. In this embodiment the two hanger elements 42 are curled ends or horns at the opposite ends of a single hanger rod element 43 that is affixed to the upper end of the slide rod 41. Another simple alternative configuration for the hanger elements is illustrated by the U-shaped hooks 42a on the rod 43a in FIG. 3. An appropriate means is provided for selectively securing the slide rod 40 for effecting varied elevational positioning of IV bags or other containers or equipment to be mounted on the support pole. In the illustrated embodiment, the selective securing arrangement is a pin 44 that engages through aligned openings in opposite sides of the tube 40 and selectively engages any one of the plurality openings 46 spaced along the length of the rod 41. A flexible retainer line 48 is attached to the upper offset support 28a and to a ring 50 through the end of the pin 44 for convenient retention of the pin near its point of use.

A detent pin 54 is installed through the legs of the J to limit lateral (side to side) movement and to prevent the mounting member from riding up and off of the partition 22. A retainer line 52 also is attached to the upper support 28a and to a ring 53 that engages through one end of the detent pin 54, which extends through aligned openings in the return leg 32 and the opposing upper portion of the plate 30 at a position spaced from the bite 34. The pin 54 extends beneath the upper horizontal bar of the partition 22 and thereby assists in preventing inadvertent disengagement of the hanger assembly from the partition 22, as noted above.

As perhaps best seen in FIGS. 2, 3 and 4, a securement latch 55 is provided for further securing the lower portion of the mounting member 24 to the door partition 22. The securement latch includes a crossbar pin 56 affixed to the main plate section 30 and protruding on its rearward side a sufficient distance to extend through the partition 22 between an adjacent pair of the partition bars. The pin 56 is threaded at its distal end. It pivotally mounts a latch bar 58 that is of a sufficiently narrow width to pass between the bars when disposed parallel thereto in a vertical position and of a length to span at least two of the bars when in a horizontal position transverse to the bars as seen in FIG. 2. A knurled nut 60 threadably engages the pin 56 to effect selective clamping engagement of the respective partition bars between the latch bar 58 and the plate section 30. Obviously, other partition-engaging arrangements can be provided, such as a washer and wing nut.

The hanger assembly 20 can be easily attached to a cage door or the like by hanging the assembly over the top edge of such a partition and may be readily secured by the insertion of the detent pin 54 and clamping of the cross bar pin latch 55. Similarly, the assembly can be simply and easily disengaged whereby it may be moved from cage to cage and door to door as needed.

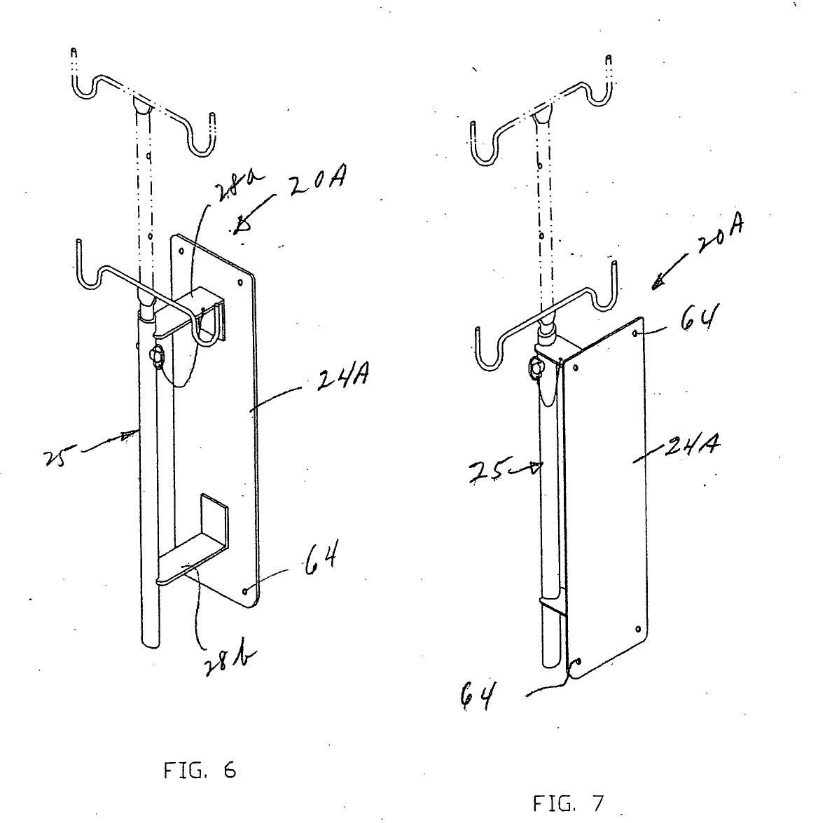

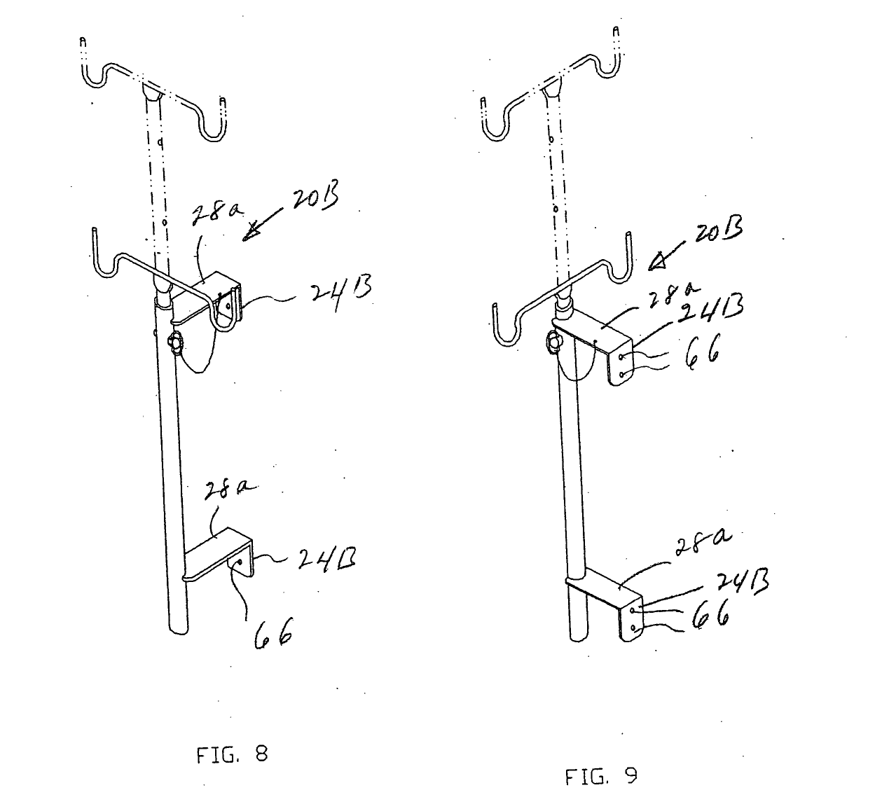

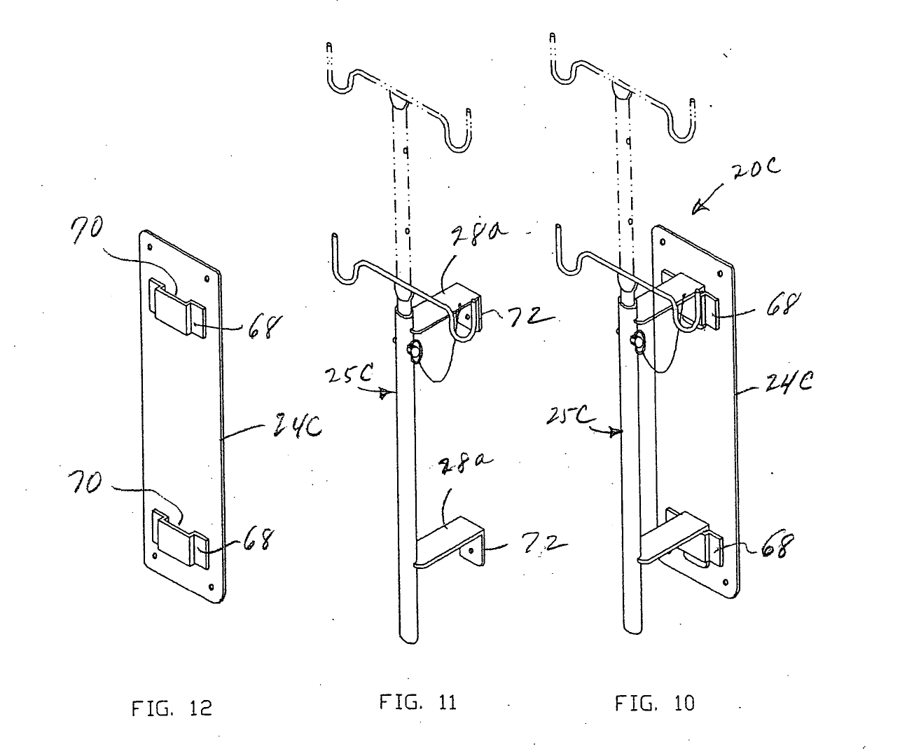

FIGS. 6-9 illustrate two embodiments of our invention, 20A (FIGS. 6 and 7) and 20B (FIGS. 8 and 9), for relatively permanent surface mounting on a partition, such as the wall of a clinic or hospital room. FIGS. 10-14 illustrate an embodiment 20C in which a surface or wall mounted base plate is provided to be attached to a partition, such as a wall of a clinic or hospital, with the hanger subassembly being detachably mounted for convenient quick mounting and easy removal. In each of these embodiments, components which correspond to components of the hanger assembly 20 of FIGS. 1-5 are identified by the same numbers and are not further described.

The embodiment 20A of FIGS. 6 and 7 includes a simple rectangular flat mounting member plate 24A with openings 64 therethrough for passage of appropriate fasteners such as screws, bolts, nails or the like (not shown) for securing the plate 24A to a vertical partition. The offset brackets 28a and 28b are suitably affixed to the mounting plate 24A.

In the embodiment 20B illustrated in FIGS. 8 and 9, each of the two offset brackets 28a includes a vertical flange 24B which serve as a mounting plate member. The flanges 24B are provided with openings 66 therethrough for passage of suitable securing means such as screws, bolts, nails or the like for mounting the assembly 20B on a vertical partition.

The embodiment 20C of FIGS. 10-12 includes a mounting plate 24C that corresponds substantially to the plate 24A of FIG. 6 with the addition of two hat-shaped straps 68 affixed thereto and which define upwardly open pockets 70 to receive depending vertical flanges 72 of the L-shaped setoff brackets 28a. It will be noted that each of the flanges 72 projects downwardly for this purpose. The pockets 70 are of a width and lateral clearance to slidably receive the flanges 72 in a snug secure fitting relationship. The straps 68 are suitably secured to the plate 24C by any suitable means, such as welding, rivets, adhesive, comolding or the like. It will also be seen that the flanges 72 correspond to the downwardly projecting flanges on the offset support brackets 28a in embodiment 20B and that the hanger subassembly 25C may be of the same construction as the hanger assembly 20B of FIGS. 8 and 9. Thus this hanger subassembly may be used either as a fixed installation or for readily detachable mounting such as on a mounting plate 24C.

The mounting member, offset brackets, pole and other components may be fashioned from sheet stainless steel, sheet plastic, stainless steel rod or other appropriate materials. The offset brackets 28a and 28b are suitably affixed to the respective mounting member, as by welding, riveting, adhesive, co-molding or the like.

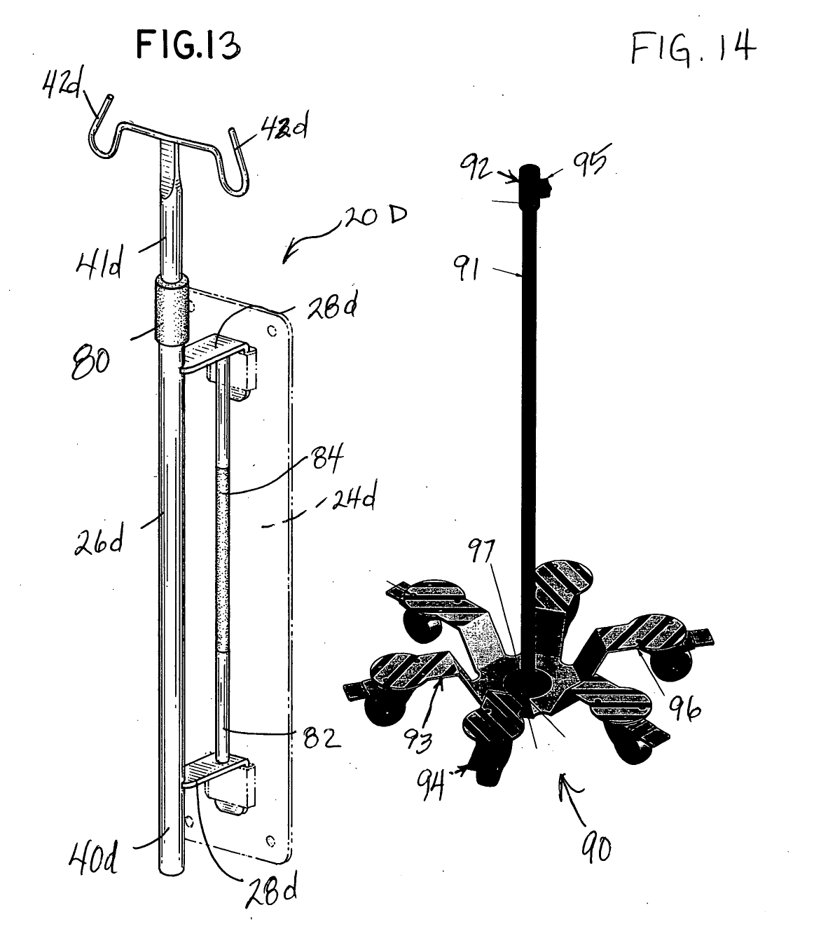

Referring to FIGS. 13-14, the embodiment 20D is particularly preferred for its construction as indicated with hooks 42d, a first pole 26d, pair of lateral offset support brackets 28d, tube 40d, and a slide rod section 41d. The means for selectively securing the slide rod 41d in various positions of extension relative to the tube 40, in this embodiment, is a compression barrel 80 that mounts on tube 40 and tightens about slide rod 41d.

Significantly, a second pole 82 extends vertically from at least one offset support 28d and most preferably between the two offset supports 28d. The pole or more precisely pole segment 82 is adjacent the attaching means by which the unit is attached to a mounting plate 24d (in phantom) and is spaced or remote from said first pole 26d. The pole 82 extends in parallel to the pole 26d. A knurled portion 84 of the pole 82 provides for a grip of a user and the pole 82 thereby acts as a remote handle for the user.

As in FIG. 14, a a mobile base 90 includes an assembly comprising an upright mobile pole 91, and adapter 92 for receiving a pole such as 40d of embodiment 20D, a pole base assembly 93, and multiple casters such as caster 94. A knob 95 on a stud screws manually into the adapter to secure a pole such as 40d. The base assembly 93 may be formed of plate, with a center section depressed relative to the casters and raised, outer caster-mounting flanges such as flange 96. The depressing of the center section and raising of the flanges provides stability to the unit. Hazard striping is included as shown, on the raised, outer flanges of the base, or other finishes are provided at customer demand. Most preferably, all casters are locking. As an alternative to the single plate formation of the base assembly 93, a suitable base assembly may be formed of multiple arms that extend from one raised, outer flange, through a depressed central section and then into a second and opposite, raised, outer flange. For six flanges and six casters, three arms are joined, and then joined to the mobile pole 91 by screws through a collar 97 on the pole 91, as is the assembly 93 shown in FIG. 14. The base 90 provides for a mobile free-standing pole for the hanger units.

Further, a shorter pole, such as the top of mobile pole 91, may be fastened to a wheelchair adjacent a wheelchair arm or back, to receive a pole such as 40d of embodiment 20D.

Thus it will be seen that novel and improved intravenous infusion equipment supports have been provided which attain the aforementioned objects. Various additional modifications of the embodiments specifically illustrated and described herein will be apparent to those skilled in the art, particularly in light of the teachings of this invention. The invention should not be construed as limited to the specific forms shown and described, but instead is set forth in the following claims.

What we claim is:

1. An intravenous infusion equipment hanger assembly comprising:
at least one mounting member including a generally flat mounting portion adapted for attachment to a partition that defines housing space for a patient and has a generally vertical planar supporting surface, the flat mounting portion having a mounting surface,
means for attaching said mounting member to the supporting surface of the partition such that (i) the mounting surface faces in a first direction toward the supporting surface and (ii) said flat mounting portion and the mounting surface are each disposed in a generally vertical position generally parallel to and adjacent the supporting surface of the partition when so attached,
a hanger including a vertically adjustable elongate first pole, at least one hanger element secured to the first pole for supporting an intravenous infusion device, and a retainer to selectively fix the first pole in different vertical positions,
at least one offset support extending laterally from said mounting member in a second direction opposite the first direction to engage and support said hanger and to position said pole (i) generally parallel to said flat mounting portion and said mounting surface, (ii) in a generally vertical orientation, and (iii) laterally from said flat mounting portion and from the partition to accommodate convenient mounting, use and removal of intravenous infusion equipment on said pole by a caregiver person when said mounting member is attached to the partition by said attaching means, and
a second pole extending vertically from the at least one offset support adjacent said attaching means and spaced from said first pole.

2. An intravenous equipment hanger assembly as in claim 1 wherein said flat mounting portion comprises a flat plate.

3. An intravenous equipment hanger assembly as in claim 2 wherein said plate has openings therethrough for passage of fasteners for affixing said plate to the partition.

4. An intravenous equipment hanger assembly as in claim 1 wherein said mounting member defines a downwardly open pocket on a side thereof opposite said hanger whereby said hanger assembly is engagable over the top of the partition for supporting said hanger assembly on the partition.

5. An intravenous equipment hanger assembly as in claim 4 including a latch mounted on said mounting member in spaced relation to said pocket for securing said mounting member to the partition at a point spaced from said pocket.

6. An intravenous equipment hanger assembly as in claim 5 including a lock element extending transversely through said pocket for locking said mounting member on the partition.

7. An intravenous equipment hanger assembly as in claim 1 wherein said mounting member is of an inverted J configuration including a main leg, a bight and a return leg, with the bight and return leg of the mounting member being on the side of said main leg opposite said hanger.

8. An intravenous equipment hanger assembly as in claim 1 wherein said mounting member is of an inverted J configuration including a main leg, a bight and a return leg, with the bight and return leg of the mounting member being on a side of said main leg opposite said hanger for hanging said assembly on the partition of an animal confining housing with said main leg and said pole on the external side of the partition on which said hanger assembly is mounted, and including a latch mounted on said mounting member in spaced relation to said bight for securing said mounting member to the partition.

9. An intravenous equipment hanger assembly as in claim 8 wherein said latch is of a configuration for movement between bars of an animal cage in a first position and movable to a second position to overlie and engage at least one such bar for securement of said mounting member to such a cage at a point spaced substantially below said bight when said assembly is mounted on an animal cage.

10. An intravenous equipment hanger assembly as in claim 8 including a lock element extending through said return leg in spaced relation to said bight for locking said mounting member on a cage.

11. An intravenous equipment hanger assembly as in claim 1 wherein said hanger is detachably mounted on said mounting member.

12. An intravenous equipment hanger assembly as in claim 1 wherein said offset support includes a flange leg disposed generally parallel to said flat mounting portion.

13. An intravenous equipment hanger assembly as in claim 12 wherein said mounting member defines at least one mounting pocket for receiving said flange leg and thereby supporting said hanger on said mounting member.

14. An intravenous equipment hanger assembly as in claim 13 wherein said mounting pocket is open upward when said mounting member is mounted on a wall and said flange leg extends downward when said hanger is oriented in a generally vertical operative hanger position and wherein said flange leg is slidably receivable in said mounting pocket for removably supporting said hanger on said mounting member.

15. An intravenous equipment hanger assembly as in claim 1 which includes
a plurality of said offset supports,
each of said offset supports including a mounting flange leg at its distal end and which is disposed generally parallel to the vertical planar supporting surface of the partition to which said hanger assembly is attached, and wherein
said second pole extends vertically between said offset supports adjacent said attaching means and spaced from said first pole.

16. An intravenous infusion equipment hanger assembly comprising:
at least one mounting member including a generally flat mounting portion adapted for attachment to a partition that defines housing space for a patient and has a generally vertical planar surface,
means for attaching said flat mounting portion to such a partition with said flat mounting portion disposed in a generally vertical position generally parallel to and adjacent such vertical planar surface of such a partition when so attached,
a hanger which includes an elongate first pole for supporting an intravenous infusion device,
a plurality of offset supports each engaging and extending laterally from said pole and joined to and extending laterally from said mounting member and supporting said hanger generally parallel to said flat mounting portion with said pole in a generally vertical position generally parallel to said flat mounting portion and spaced laterally from said flat mounting portion and from the respective partition surface to accommodate convenient mounting, use and removal of intravenous infusion equipment on said pole by a caregiver person when said mounting member is attached to a such a partition by said attaching means, each of said offset supports including a mounting flange leg at its distal end and which is disposed generally parallel to such vertical planar surface of such a partition to which said hanger assembly is attached, wherein each of said flange legs has openings therethrough for passage of fasteners for affixing said flange legs to such a partition, and
a second pole extending vertically between said offset supports adjacent said attaching means and spaced from said first pole.

17. An intravenous equipment hanger assembly as in claim 16 wherein each of said offset supports is a generally L shaped bracket which includes a first leg affixed to and extending generally normal to said pole and a distal leg which extends generally parallel to the vertical planar supporting surface of the partition to which said hanger assembly is attached.

18. An intravenous equipment hanger assembly as in claim 17 wherein said mounting member defines a plurality of mounting pockets which are open upward when said mounting member is mounted on the partition and said flange legs extend downward when said hanger is oriented in a generally vertical operative hanger position and wherein said flange legs are slidably receivable in said mounting pockets for removably supporting said hanger on said mounting member.

19. An intravenous equipment hanger assembly as in claim 1, wherein said first pole includes multiple telescopically engaged sections and means for securing said sections in selected positions of extension of one of said sections relative to another of said sections.
